(19) United States
(12) Patent Application Publication
(10) Pub. No.: US 2009/0037270 A1
(43) Pub. Date: Feb. 5, 2009

(54) SYSTEM, METHOD, AND COMPUTER PROGRAM PRODUCT FOR COMPENSATING A USER FOR VIEWING AN ADVERTISEMENT AND PURCHASING A GOOD OR SERVICE

(76) Inventor: Debabrata Patro, Pune (IN)

Correspondence Address: Zilka-Kotab, PC, P.O. BOX 721120, SAN JOSE, CA, 95172-1120, US

(21) Appl. No.: 11/833,837

(22) Filed: Aug. 3, 2007

(51) Int. Cl. G06Q 30/00

(52) U.S. Cl. 705/14

(57) ABSTRACT

A system, method, and computer program product are provided for compensating a user for viewing an advertisement and purchasing a good or service. In use, an advertisement is presented for a good or service. Additionally, a user is compensated a first amount for viewing the advertisement. Further, the user is compensated a second amount for purchasing the good or service.

### FIELD OF THE INVENTION

The present invention relates to data processing, and more particularly to providing incentives to viewers of advertisements.

### BACKGROUND

Advertisements are an everyday part of life. They appear in web pages, television programs, movies, and almost any venue where a user has access to information. The effectiveness of advertisements, however, is not always easy to determine. Currently, the effectiveness of advertisements is estimated by either a number of selections the advertisement receives, or is based on an estimated viewing of the advertisement. In most cases, there is very little incentive for users to click through, view the advertisements, make a purchase, etc.

There is thus a need for addressing these and/or other issues associated with the prior art.

### SUMMARY

A system, method, and computer program product are provided for compensating a user for viewing an advertisement and purchasing a good or service. In use, an advertisement is presented for a good or service. Additionally, a user is compensated a first amount for viewing the advertisement. Further, the user is compensated a second amount for purchasing the good or service.

### BRIEF DESCRIPTION OF THE DRAWINGS

FIG. 1 illustrates a network architecture, in accordance with one possible embodiment.

FIG. 2 illustrates an exemplary system, in accordance with one embodiment.

FIG. 3 shows a method for compensating a user for viewing an advertisement and purchasing a good or service, in accordance with one embodiment.

FIG. 4 shows a method for compensating a user for viewing an advertisement and purchasing a good and/or service, in accordance with another embodiment.

FIG. 5 shows a system for compensating a user for viewing an advertisement and purchasing a good and/or service, in accordance with one embodiment.

### DETAILED DESCRIPTION

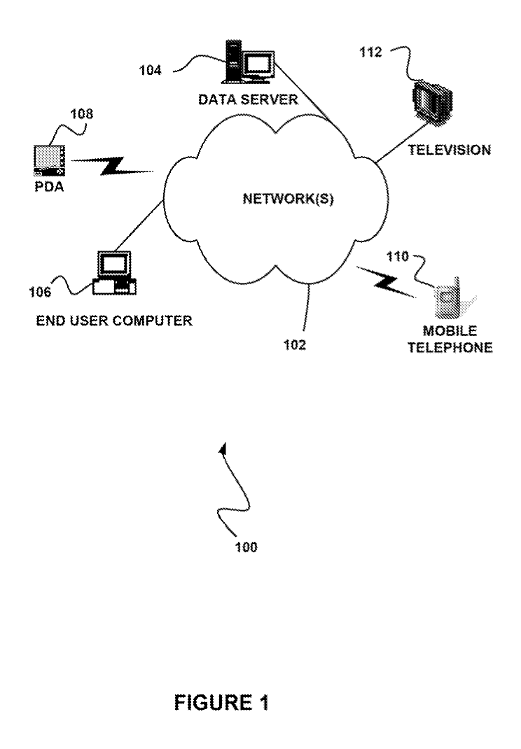

FIG. 1 illustrates a network architecture 100, in accordance with one possible embodiment. As shown, at least one network 102 is provided. In the context of the present network architecture 100, the network 102 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 102 may be provided.

Coupled to the network 102 is a plurality of devices. For example, a server computer 104 and an end user computer 106 may be coupled to the network 102 for communication purposes. Such end user computer 106 may include a desktop computer, lap-top computer, and/or any other type of logic. Still yet, various other devices may be coupled to the network 102 including a personal digital assistant (PDA) device 108, a mobile phone device 110, a television 112, etc.

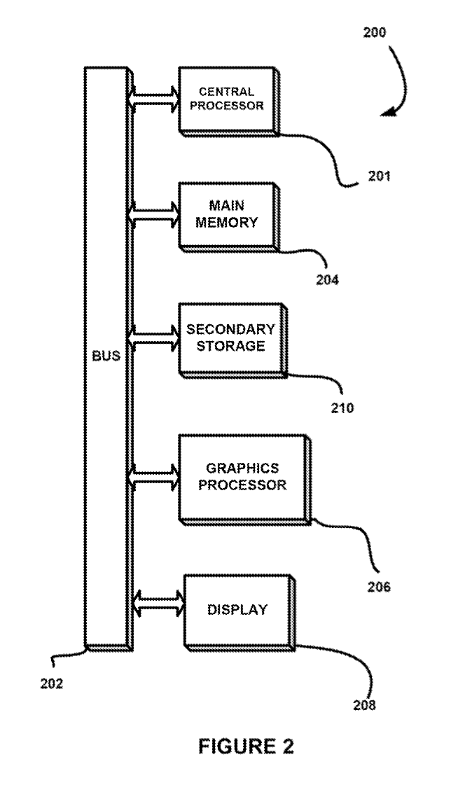

FIG. 2 illustrates an exemplary system 200, in accordance with one embodiment. As an option, the system 200 may be implemented in the context of any of the devices of the network architecture 100 of FIG. 1. Of course, the system 200 may be implemented in any desired environment.

As shown, a system 200 is provided including at least one central processor 201 which is connected to a communication bus 202. The system 200 also includes main memory 204 [e.g. random access memory (RAM), etc.]. The system 200 also includes a graphics processor 206 and a display 208.

The system 200 may also include a secondary storage 210. The secondary storage 210 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 204 and/or the secondary storage 210. Such computer programs, when executed, enable the system 200 to perform various functions (to be set forth below, for example). Memory 204, storage 210 and/or any other storage are possible examples of computer-readable media.

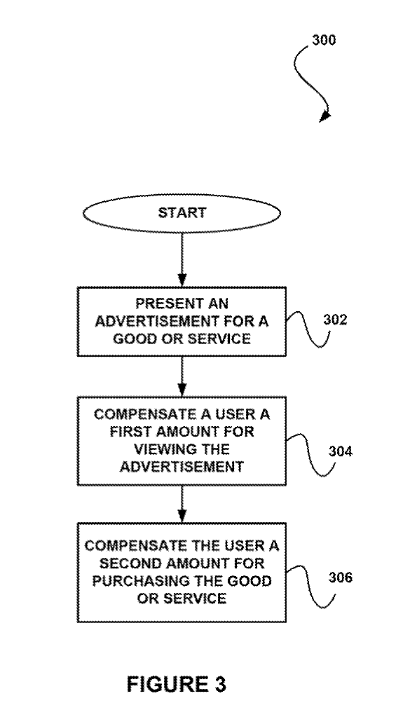

FIG. 3 shows a method 300 for compensating a user for viewing an advertisement and purchasing a good or service, in accordance with one embodiment. As an option, the method 300 may be implemented in the context of the details of FIGS. 1 and/or 2. Of course, however, the method 300 may be carried out in any desired environment. Further, the aforementioned definitions may equally apply to the description below.

As shown in operation 302, an advertisement is presented for a good or service. In the context of the present description, the term advertisement may refer to a survey, questionnaire, promotional content, product/service information, and/or anything that is designed to attract attention. In one embodiment, the advertisement may include a digital advertisement.

Further, the advertisement may be presented in a variety of ways. In various embodiments, the advertisement may be presented on a computer, television, PDA, mobile phone, and/or any other mobile or stationary device capable of presenting advertisements. In such embodiments, the advertisement may be presented using web pages, television programs, movies, on-demand programming, audible media, and/or any other media capable of presenting advertisements. Of course, the foregoing examples are set forth for illustrative purposes only and should not be construed as limiting in any manner whatsoever.

In operation 304, a user is compensated a first amount for viewing the advertisement. In the context of the present description, a user may refer to any person or entity capable of viewing an advertisement. For example, in various embodiments, the user may be any user of a device presenting the advertisement, such as one of the devices mentioned above and/or described in the context of FIG. 1.

The user may be compensated in a variety of ways. In one embodiment, the user may be compensated by being awarded points. In various other embodiments, the compensation may include monetary compensation, coupons for redeeming goods and/or services, discounts on purchases of products and/or services, and/or any other compensation beneficial to the user.

Additionally, the amount that the user is compensated may vary depending on a variety of factors. In various embodiments, the amount that the user is compensated may depend on a duration which the advertisement was viewed, the type of advertisement, the content of the advertisement, the method upon which the advertisement was viewed, and/or the number of times the user clicked through the advertisement. Of course, such factors are described strictly for exemplary purposes as any number of factors may be used to determine the amount of compensation provided to the user.

Further, in operation 306 the user is compensated a second amount for purchasing the good or service. In one embodiment, the user may be compensated the second amount for purchasing the good or service as a result of viewing the advertisement. Additionally, the user may be compensated in a variety of ways. In various embodiments, the compensation may include monetary compensation, coupons and/or points for redeeming products and/or services, discounts on purchases of products and/or services, and/or any other compensation beneficial to the user. In different embodiments, the second amount of compensation may or may not take the same form or be of the same type as the first amount of compensation.

In addition, the amount that the user is compensated may vary depending on a variety of factors. For example, the amount that the user is compensated may depend on a cost of the good or service purchased, the type of good or service purchased, the method upon which the good or service was purchased, or any other factor corresponding to the good or service. Of course, such factors are described strictly for exemplary purposes as any number of factors may determine the amount of compensation provided to the user.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

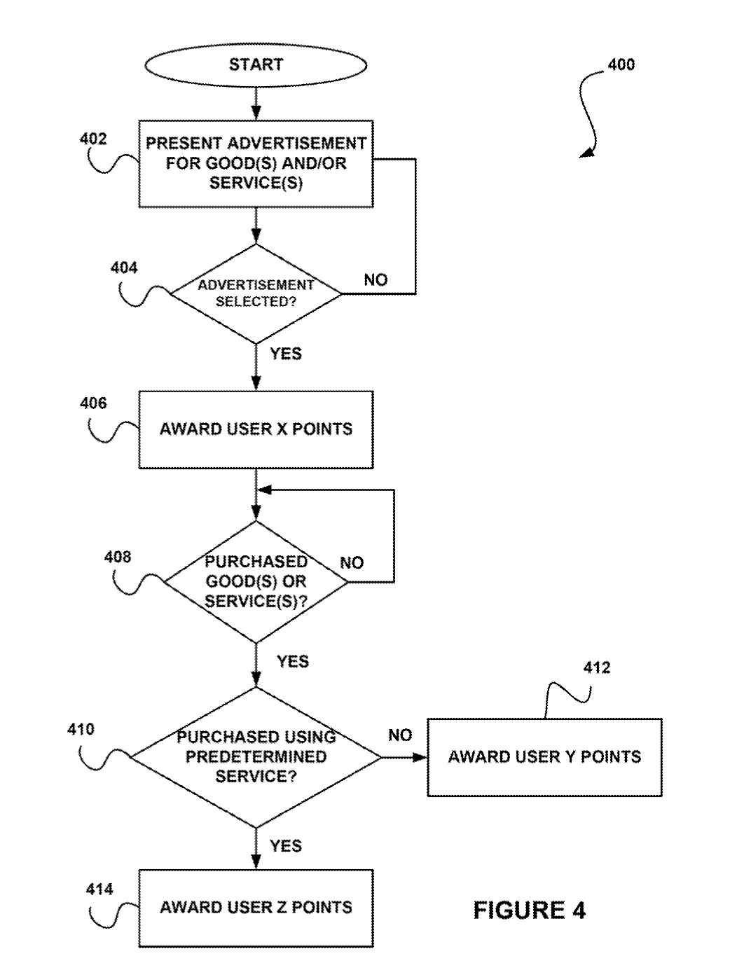

FIG. 4 shows a method 400 for compensating a user for viewing an advertisement and purchasing a good and/or service, in accordance with another embodiment. As an option, the method 400 may be implemented in the context of the details of FIGS. 1-3. Of course, however, the method 400 may be carried out in any desired environment. Further, the aforementioned definitions may equally apply to the description below.

As shown in operation 402, an advertisement is presented to a user for a good and/or service. The advertisement may include a digital advertisement, for example. In operation 404, it is determined whether an advertisement has been selected. In the context of the present description, the term “selected” refers to any indication that the user has viewed the advertisement. For example, in various embodiments, the act of selecting may include, but is not limited to, clicking through one or multiple screens of an advertisement, highlighting an advertisement, reading an advertisement which uses human detection sensing equipment, and/or any other indication that the user has viewed an advertisement.

In one embodiment, the advertisement may be selected by clicking on the advertisement utilizing an input device. In such case, the user may use the input device to click through multiple screens of the advertisement, for example. In various embodiments, such input device may include a television input device controller (e.g. Tivo® controller), computer interface (e.g. keyboard, mouse, etc.), telephone keypad or voice input device, PDA input interface, or any other input device, for that matter.

If it is determined that an advertisement is selected, the user is awarded a first number of points (e.g. X points), as shown in operation 406. The amount of points awarded may vary depending on a variety of factors. For example, the amount of points awarded to the user may depend on a duration which the advertisement was viewed, the type of advertisement, the content of the advertisement, and/or the method upon which the advertisement was viewed. In other embodiments, the first number of points may be fixed.

In one embodiment, the user may be awarded points for every time the user selects the advertisement or a portion of the advertisement. For example, the advertisement may be comprised of multiple portions which the user may click on to view. Thus, as the user clicks through all of the portions of the advertisement, the user may be awarded points for each portion viewed. In one embodiment, the user may be awarded additional points for viewing, or clicking through, the entire advertisement. In another embodiment, the user may be awarded the same amount of points for viewing one portion of the advertisement with respect to other portions of the advertisement.

In operation 408, it is determined whether the good and/or service has been purchased as a result of viewing the advertisement. In one embodiment, the advertisement may be viewed and the good or service may be purchased during the same transaction. For example, the user may click through an advertisement, generating points for viewing the advertisement, and in turn, purchase the good or service in the same session.

In another embodiment, the advertisement may be viewed during a first transaction and the good or service may be purchased during a second transaction after the first transaction. For example, the user may click through or view the advertisement, generating points for viewing the advertisement, and in turn, wait a period of time to purchase the good or service. In a second transaction, the user may decide to purchase the good or service based on the previously viewed advertisement. Thus, the user may be awarded points for purchasing the good or service as a result of the advertisement.

In one embodiment, a coupon may be issued in response to the viewing of the advertisement. Such coupon may be used to redeem points at a later purchase date. For example, upon selecting or clicking through the advertisement, the user may be issued a coupon indicating that user has viewed the advertisement. Thus, the user may present the coupon at a later time of purchase and be awarded points for purchasing the good or service. To this end, the coupon may be issued in response to the viewing of the advertisement, and the good or service may be purchased utilizing the coupon.

In another embodiment, a cross-check may be performed between the good or service purchased, and all advertisements viewed by the user in a preceding period of a configurable number of clays (e.g. 7 days). Such check may be used to determine whether the purchase was a result of viewing the advertisement. For example, if the user has made a purchase, and an inspection of the advertisements viewed by the user in the past 7 days reveals that the user has viewed/clicked a correlating advertisement, the user may be awarded points for purchasing the good or service as a result of viewing the advertisement. Such inspection may be accomplished by determining whether the points awarded to the user for viewing advertisements corresponded to the good and/or service purchased, for example.

If it is determined that the user has purchased the good and/or service, it is determined whether the good and/or service has been purchased using a predetermined service, as shown in operation 410. In one embodiment, the predetermined service may include a mobile wireless service. In various other embodiments, various predetermined services may include television services, internet services, movie services and on-demand services, and any other services which a user may use to purchase a good and/or service.

If it is determined that the user has not purchased the good and/or service using a predetermined service, the user is awarded a second number of points (e.g. Y points), as shown in operation 412. If, however, it is determined that the user has purchased the good and/or service using a predetermined service, the user is awarded a third, number of points (e.g. Z points), as shown in operation 414. The number of points awarded for each of the operations may vary.

For example, a service provider may want to reward the user for making a purchase using a predetermined service (e.g. a wireless service, etc.) of the service provider. In this case, the amount of points awarded to a user for making a purchase using the predetermined service (e.g. Z) may be greater than the amount of points awarded had the user not used the predetermined service (e.g. Y). Thus, the amount of points awarded for the purchase may be augmented, based on the determination shown in operation 410.

In another embodiment, a selection of services may not exist. In such case, the amount of points awarded to the user may be same for any purchase of goods and/or services (e.g. after operation 408). Thus, the amount of points awarded to the user may be the same for making a purchase using the predetermined service and purchasing the service without using the predetermined service.

The number of points awarded to the user may also vary based on other factors (e.g. the good or service itself, etc.). In one embodiment, the good or service may be identified. In such case, the second amount awarded to the user may be selected based on the good or service.

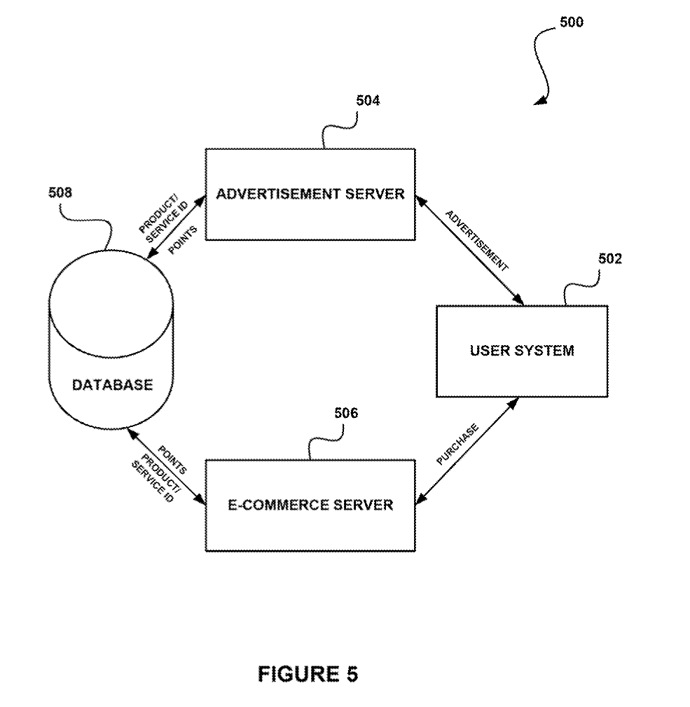

FIG. 5 shows a system 500 for compensating a user for viewing an advertisement and purchasing a good and/or service, in accordance with one embodiment. As an option, the system 500 may be implemented in the context of the details of FIGS. 1-4. Of course, however, the system 500 may be implemented in any desired environment. Further, the aforementioned definitions may equally apply to the description below.

As shown, a user system 502 is provided. The user system 502 communicates with an advertisement server 504 and an E-Commerce server 506. As further shown, the advertisement server 504 and the E-Commerce server 506 both communicate with a database 508.

In the context of the present description, the term E-Commerce may refer to distributing, buying, selling, servicing, etc. of products or services over electronic systems such as the Internet and other computer networks. In various embodiments, the E-Commerce server 506 may be a venue for commercial transactions, and may be configured to include electronic funds transfer, supply chain management, online transaction processing, electronic data interchange (EDI), automated inventory management systems, automated data collection systems, etc.

Additionally, in the context of the present description, the term advertisement server refers to any system capable of supplying an advertisement to a user. For example, in various embodiments, the advertisement server 504 may include, but is not limited to an advertisement publisher system, service provider system, merchant system, or any other system capable of providing a user with an advertisement.

In operation, a user of the user system 502 may view an advertisement provided by the advertisement server 504. The user system 502 may represent a number of systems available to the user. In various embodiments, the user system 502 may include a PDA, computer, mobile telephone, television, or any other system capable of presenting advertisements to a user.

Additionally, the advertisement may be provided to the riser system 502 in a variety of ways. For example, the advertisement may be provided to a user viewing a web page, television program, movie, and/or any other media capable of being viewed on the user system 502. Further, the user system 502 may communicate with the advertisement server 504 in various ways.

For example, the user system 502 may communicate with the advertisement server 504 over a network such as the networks as described in the context of FIG. 1. In one embodiment, the user system 502 may include a mobile wireless device. In such case, the user system 502 may communicate with the advertisement server 504 over a wireless network.

Upon viewing the advertisement, the user of the user system 502 may be awarded a first number of points by the advertisement server 504. The viewing of the advertisement may involve clicking though the advertisement, for example. As the user clicks through the advertisement, the user may be continuously accumulating points. These points may be exchanged for any goods, discounts, etc., and/or used as a part of any other promotion scheme, for example.

The points awarded to the user may be communicated from the advertisement server 504 to the database 508 for tracking purposes. Additionally, unique user identification information corresponding to the user may be sent to the database 508 such that the number of points awarded to the user is stored with the user identification information. In various embodiments, such user identification information may include product/service identification information for the user, unique login information, unique user system information (e.g. IP address, phone number, etc.), and/or any information which may be used to identify the user.

Once the user has viewed the advertisement (e.g. clicked through the advertisement), the user may decide to purchase the goods and/or services corresponding to the advertisement. Thus, the user may solidify a purchase by communicating with the E-Commerce server 506. Once the user has purchased the goods and/or services, the E-Commerce server 506 may award a second number of points to the user for purchasing the goods and/or services as a result of clicking through the advertisement.

In one embodiment, the second number of points awarded to the user for purchasing the goods and/or services may be greater than the first number of points awarded for viewing the advertisement. For example, every time the user views an advertisement, or clicks through a portion of an advertisement, the user may be awarded one point. On the other hand, when the user purchases a good and/or service as a result of viewing the advertisement, the user may be awarded 10 points for every unit of money spent (e.g. 10 points/$1 spent). Additionally, a conversion rate for the amount of points awarded to the user for purchases may be modified. For example, the user may be awarded 10 points/$1 spent on food purchases and 25 points/$1 spent on digital media purchases.

By awarding points for making purchases as a result of viewing advertisements, the user may have an incentive to view more advertisements, and to make purchases by clicking through the advertisements. By determining whether the purchase was a result of the user clicking through the advertisement, advertisement publishers may use information corresponding to the purchase to prepare advertisements directed to specific users. Additionally, by determining whether the purchase was a result of viewing the advertisement, the advertisement publishers may determine the effectiveness of certain advertisements.

An advertiser publisher may determine how many people viewed the advertisement, as well as how many of the viewings resulted in a sale. By tracking not only clicks on the advertisement, but also the correlated sales, advertisement publishers may reduce the impact of click fraud and be able to track the tree effectiveness of their advertisements. Thus, advertisement publishers may be able to differentiate between the total number of advertisement views/clicks and the actual amount of sales which resulted from the advertisement.

In one embodiment, the amount of points awarded to the user for making the purchase as a result of viewing the advertisement may be augmented if it is determined that the user made the purchase through a service offered by the advertisement publisher and/or the E-Commerce server (e.g. good/service provider service). For example, a larger number of points may be awarded to the user if the purchase was made through mobile/micro-payment services of a customer service provider supplying the advertisement for a particular good/service.

Thus, the customer service provider may more easily correlate the purchase with the associated advertisement click through, using the customer service provider's service. This is one reason for providing the user with an enhanced incentive to use the mobile/micro-payment services of the customer service provider, for example. In one embodiment, the user may be awarded three groups of points, a first group of points for viewing the advertisement of the customer service provider, a second group of points for purchasing the good and/or service as a result of viewing the advertisement, and a third group of points for using the service provider's service to make the purchase.

In another embodiment, the third group of points awarded to the user may be a result of the user using a method of purchase preferred by a payment acceptor. For example, the service provider may award additional points to a user using a preferred payment method such as a mobile payment or a regular payment method. Such, preferred payment technique may be a method of payment established in a service agreement between the user and the service provider.

The points awarded to the user may be communicated from the E-Commerce server 506 to the database 508 for storage. Unique user identification information corresponding to the user may also be sent to the database 508 such that the number of points awarded to the user is stored with the user identification information. These points may be exchanged for any goods, discounts, etc. and/or used as a part of any other promotion scheme.

For example, the points may be exchanged for additional talk time, movies, downloads (e.g. music, video, etc.), service packages, airline miles, and/or any other good or service. Additionally, because the database 508 stores all of the points awarded to the user, the first amount and the second amount awarded to the user may be tracked utilizing the database 508. In various embodiments, the points awarded to the user may be stored as a total number of points (i.e. the first number of points combined with the second number of points), and/or a total number of points along with the number of points awarded for viewing the advertisement (i.e. the first number of points) and the number of points for making a purchase (i.e. the second number of points.

In one embodiment, a cross-check between the product/service purchased and all advertisements viewed by the user in a preceding period of a configurable number of days (e.g. 7 days) may be completed. For example, if the user has made a purchase, and an inspection of the advertisements viewed by the user in the past 7 days reveals that the user has viewed/clicked the advertisement, the user may be awarded points for purchasing the good/service as a result of viewing the advertisement. Such inspection may be accomplished by determining whether the points awarded to the user for viewing advertisements corresponded to the good and/or service purchased. Thus, the viewing of the advertisement may be correlated with the purchase of the good or service utilizing the database 508.

It should be noted that, even without a comprehensive tracking system like the one disclosed above, the user may make a purchase at a later time or date while still being awarded the second number of points for making the purchase as a result of the advertisement (e.g. after a movie the user is watching is complete). For example, in one embodiment, a coupon may be displayed at the end of the advertisement which may be used at the time of a future purchase to link the advertisement viewing with the purchase. Thus, upon use of the coupon with a purchase, the user may be awarded points for purchasing the good/service as a result of viewing the advertisement. In one embodiment, such coupon may contain information about the user (e.g. a personalized coupon).

As shown in FIG. 5, the advertisement server 504 and the E-Commerce server 506 are separate systems. However, in another embodiment, the advertisement server 504 and the E-Commerce server 506 may be the same system. In such case, the user system 502 may communicate with one server which provides the advertisement and the first number of points for viewing the advertisement, as well as the second number of points for purchasing the goods and/or services. Thus, the one server may communicate with the database 508 for the purposes of storing and accessing points awarded to the user.

As further shown, the advertisement server 504 and the E-Commerce server 506 communicate with the same database 508. In another embodiment, the advertisement server 504 and the E-Commerce server 506 may communicate with separate databases. In such case, the separate databases (or associated servers) may be in communication such that the points awarded to the user may be stored as a total number of accumulated points in one of the databases.

It should be noted that the database 508 may be a local or remote database. For example, the database 508 may be local to the advertisement server 504 or the E-Commerce server 506. In a situation where the advertisement server 504 and the E-Commerce server 506 are part of the same server, the database 508 may be a local or remote to the single server.

Additionally, the communication between the database 508 and the advertisement server 504 and E-Commerce server 506 may be accomplished in a variety of ways. For example, the communication may be accomplished using a network such as one of the networks as described in the context of FIG. 1. Additionally, the communication between the database 508, and the advertisement server 504 and E-Commerce server 506 may be accomplished utilizing a system such as the system as described in the context of the details of FIG. 2.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
presenting an advertisement for a good or service;
compensating a user a first amount for viewing the advertisement; and
compensating the user a second amount for purchasing the good or service.

2. The method of claim 1, wherein the advertisement includes a digital advertisement.

3. The method of claim 1, wherein the viewing is confirmed in response to the user selecting the advertisement.

4. The method of claim 3, wherein the advertisement is selected by clicking on the advertisement utilizing an input device.

5. The method of claim 1, wherein the advertisement is viewed and the good or service is purchased during the same transaction.

6. The method of claim 1, wherein the advertisement is viewed during a first transaction and the good or service is purchased during a second transaction alter the first transaction.

7. The method of claim 1, wherein a coupon is issued in response to the viewing of the advertisement, and the good or service is purchased utilizing the coupon.

8. The method of claim 1, and further comprising determining whether the good or service was purchased using a predetermined service.

9. The method of claim 8, wherein the predetermined service includes a mobile wireless service.

10. The method of claim 8, wherein the second amount is augmented, based on the determination.

11. The method of claim 1, and further comprising identifying the good or service.

12. The method of claim 11, wherein the second amount is selected, based on the good or service.

13. The method of claim 1, wherein the first amount includes a first amount of points and the second amount includes a second amount of points.

14. The method of claim 13, wherein the points are redeemable for other goods or services.

15. A computer program product embodied on a computer readable medium, comprising:
computer code for presenting an advertisement for a good or service;
computer code for compensating a user a first amount for viewing the advertisement; and
computer code for compensating the user a second amount for purr basing the good or service.

16. A system, comprising:
a first server for presenting an advertisement for a good or service and compensating a user a first amount for viewing the advertisement; and
a second server for compensating the user a second amount for purchasing the good or service.

17. The system of claim 16, wherein the advertisement is presented utilizing a mobile device.

18. The system of claim 16, wherein the first server and the second server are in communication with a database.

19. The system of claim 18, wherein the first amount and the second amount are tracked utilizing the database.

20. The system of claim 18, wherein the viewing of the advertisement is correlated with the purchase of the good or service utilizing the database.
